(19) United States
(12) Patent Application Publication
(10) Pub. No.: US 2020/0384423 A1
(43) Pub. Date: Dec. 10, 2020

(54) ZEOLITE MEMBRANE COMPLEX AND METHOD OF PRODUCING ZEOLITE MEMBRANE

(71) Applicant: NGK INSULATORS, LTD., Nagoya-Shi (JP)

(72) Inventors: Aya MIURA, Nagoya-Shi (JP); Ryotaro YOSHIMURA, Nagoya-Shi (JP); Kenichi NODA, Nagoya-Shi (JP)

(73) Assignee: NGK INSULATORS, LTD., Nagoya-Shi (JP)

(21) Appl. No.: 17/000,654

(22) Filed: Aug. 24, 2020

Related U.S. Application Data
(63) Continuation of application No. PCT/JP2019/008371, filed on Mar. 4, 2019.

(30) Foreign Application Priority Data
Mar. 23, 2018 (JP) 2018-056676
Mar. 23, 2018 (JP) 2018-056677

(51) Int. Cl. B01D 71/02; B01D 69/10; C01B 39/54; C01B 39/46; B01D 53/22

(52) U.S. Cl. CPC B01D 71/028; B01D 69/10; B01D 53/228; C01B 39/46; C01B 39/54

(57) ABSTRACT

Part of a zeolite membrane of a zeolite membrane complex is set in pores of a support over a boundary surface between the zeolite membrane and the support. With respect to a main element constituting the zeolite membrane, a distance in a depth direction perpendicular to the boundary surface between a position at which a ratio (B/C)/A is 0.8 and the boundary surface is preferably not smaller than 0.01 μm and not larger than 5 μm. B/C is a value obtained by dividing an atomic percentage B of the main element inside the support by a porosity C of the support. The ratio (B/C)/A is a ratio of the value to an atomic percentage A of the main element in the zeolite membrane.

### CROSS-REFERENCE TO RELATED APPLICATION

The present application is a continuation application of International Application No. PCT/JP2019/8371 filed on Mar. 4, 2019, which claims priority to Japanese Patent Application No. 2018-56676 filed on Mar. 23, 2018 and Japanese Patent Application No. 2018-56677 filed on Mar. 23, 2018. The contents of these applications are incorporated herein by reference in their entirety.

### TECHNICAL FIELD

The present invention relates to a zeolite membrane complex where a zeolite membrane is formed on a support.

### BACKGROUND ART

Currently, various kinds of researches and developments are carried out on applications such as separation of specific gases, adsorption of molecules, using zeolite in the form of a zeolite membrane complex which is obtained by forming a zeolite membrane on a support. In the case where the support is porous, part of the zeolite membrane is set in the pores of the support over the boundary surface between the zeolite membrane and the support. When the infiltration depth of the zeolite into the support is shallow, delamination of the zeolite membrane may occur because of poor adhesion between the zeolite membrane and the support. When the infiltration depth of the zeolite into the support is deep, the gas permeation rate decreases because of increased permeation resistance. In International Publication WO 2016/084845 (Document 1), a portion in a support at which a void first appears on a straight line running vertically from the support surface to the inside of the support is defined as an end portion of an infiltration layer of zeolite in the support, and the distance between the end portion and the support surface is obtained as the thickness of the infiltration layer.

In the zeolite membrane complex, there is a case where the zeolite infiltrates inward beyond the above-described void in the support. Document 1 does not take account of increase of the permeation resistance due to the zeolite on the inner side from the void. Thus, in the zeolite membrane complex of Document 1, there is a possibility that the gas permeation rate may be smaller than a desired rate even when the infiltration layer of zeolite has a predetermined thickness.

### SUMMARY OF INVENTION

The present invention is intended for a zeolite membrane complex, and it is an object of the present invention to increase permeability of a zeolite membrane complex while maintaining adhesion of a zeolite membrane to a support.

The zeolite membrane complex according to a preferred embodiment of the present invention includes a porous support, and a zeolite membrane formed on the support. Part of the zeolite membrane is set in pores of the support over a boundary surface between the zeolite membrane and the support. A distance between the boundary surface and a position in a depth direction perpendicular to the boundary surface is not larger than 5 μm, where with respect to a main element constituting the zeolite membrane, a ratio (B/C)/A of a value obtained by dividing an atomic percentage B at the position inside the support by a porosity C of the support, to an atomic percentage A in the zeolite membrane is 0.8. By the present invention, it is possible to increase permeability of the zeolite membrane complex while maintaining adhesion of the zeolite membrane to the support.

Preferably, the distance is not larger than 4 μm. More preferably, the distance is not larger than 3 μm.

The zeolite membrane complex according to another preferred embodiment of the present invention includes a porous support, and a zeolite membrane formed on the support. Part of the zeolite membrane is set in pores of the support over a boundary surface between the zeolite membrane and the support. A distance between the boundary surface and a position in a depth direction perpendicular to the boundary surface is not more than 50 times a mean pore diameter of the support in a vicinity of a surface on which the zeolite membrane is formed, where with respect to a main element constituting the zeolite membrane, a ratio (B/C)/A of a value obtained by dividing an atomic percentage B at the position inside the support by a porosity C of the support, to an atomic percentage A in the zeolite membrane is 0.8. By the present invention, it is possible to increase permeability of the zeolite membrane complex while maintaining adhesion of the zeolite membrane to the support.

Preferably, the main element is an element that is not essentially contained in the support.

Preferably, the zeolite membrane contains any two or more of silicon, aluminum, and phosphorus, or silicon.

Preferably, the support is an alumina sintered body or a mullite sintered body.

The present invention is also intended for a method of producing a zeolite membrane complex. The method of producing a zeolite membrane complex according to a preferred embodiment of the present invention includes a) synthesizing zeolite by hydrothermal synthesis and obtaining seed crystals from the zeolite, b) depositing the seed crystals on a porous support, and c) immersing the support in a starting material solution and growing zeolite from the seed crystals by hydrothermal synthesis, to thereby form a zeolite membrane on the support. The method may further include d) removing a structure-directing agent from the zeolite membrane after the operation c). Part of the zeolite membrane is set in pores of the support over a boundary surface between the zeolite membrane and the support. A distance between the boundary surface and a position in a depth direction perpendicular to the boundary surface is not larger than 5 μm, where with respect to a main element constituting the zeolite membrane inside the support, a ratio (B/C)/A of a value obtained by dividing an atomic percentage B at the position inside the support by a porosity C of the support, to an atomic percentage A in the zeolite membrane is 0.8. By the present invention, it is possible to increase permeability of the zeolite membrane complex while maintaining adhesion of the zeolite membrane to the support.

Preferably, the distance is not larger than 4 μm. More preferably, the distance is not larger than 3 μm.

The method of producing a zeolite membrane complex according to another preferred embodiment of the present invention includes a) synthesizing zeolite by hydrothermal synthesis and obtaining seed crystals from the zeolite, b) depositing the seed crystals on a porous support, and c) immersing the support in a starting material solution and growing zeolite from the seed crystals by hydrothermal synthesis, to thereby form a zeolite membrane on the support. The method may further include d) removing a structure-directing agent from the zeolite membrane after the operation c). Part of the zeolite membrane is set in pores of the support over a boundary surface between the zeolite membrane and the support. A distance between the boundary surface and a position in a depth direction perpendicular to the boundary surface is not more than 50 times a mean pore diameter of the support in a vicinity of a surface on which the zeolite membrane is formed, where with respect to a main element constituting the zeolite membrane inside the support, a ratio (B/C)/A of a value obtained by dividing an atomic percentage B at the position inside the support by a porosity C of the support, to an atomic percentage A in the zeolite membrane is 0.8. By the present invention, it is possible to increase permeability of the zeolite membrane complex while maintaining adhesion of the zeolite membrane to the support.

Preferably, a specific surface area of the seed crystals obtained in the operation a) is not smaller than 10 m²/g and not larger than 150 m²/g. A strength obtained from a crystal component at a diffraction angle 2θ indicating a maximum peak in a range of diffraction angle 2θ from 12° to 25° in an X-ray diffraction pattern obtained by emitting X-ray to the seed crystals is not less than once and not more than 30 times that obtained from an amorphous component.

Preferably, the seed crystals are deposited in the operation b) on a substantially vertical surface or a downward-facing surface in production of the zeolite membrane complex, out of surfaces of the support.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a sectional view of a zeolite membrane complex;

FIG. 2 is an enlarged sectional view of the zeolite membrane complex;

FIG. 3 is a flowchart of production of the zeolite membrane complex;

FIG. 4 is another flowchart of production of the zeolite membrane complex; and

FIG. 5 is a view of an apparatus for separating a mixed gas.

### DESCRIPTION OF EMBODIMENTS

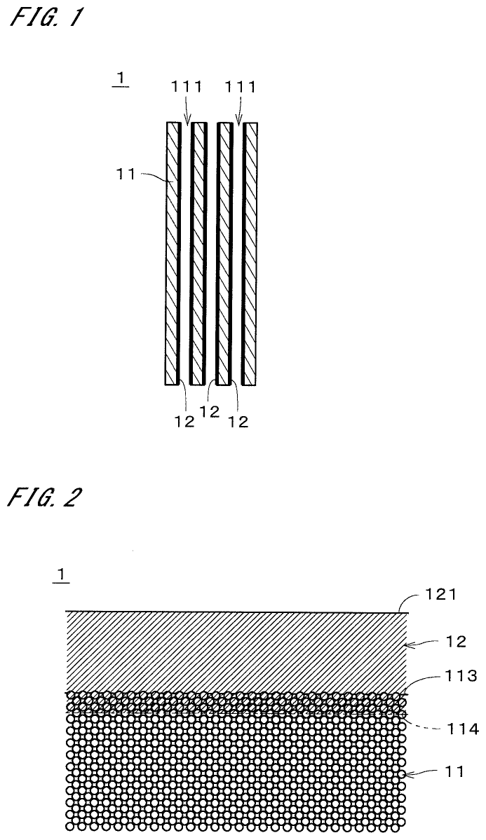

FIG. 1 is a sectional view of a zeolite membrane complex 1 according to an embodiment of the present invention. The zeolite membrane complex 1 includes a support 11 and a zeolite membrane 12 formed on the support 11. In the example illustrated in FIG. 1, the support 11 is a monolith support, having a substantially circular columnar shape, where a plurality of through holes 111 each extending in a longitudinal direction (i.e., the vertical direction in the drawing) are formed. Each through hole 111 (i.e., cell) has, for example, a substantially circular cross-section perpendicular to the longitudinal direction. In the illustration of FIG. 1, the diameter of the through holes 111 is greater than the actual diameter, and the number of through holes 111 is smaller than the actual number. The zeolite membrane 12 is formed on the inner surfaces of the through holes 111 and covers substantially the entire inner surfaces of the through holes 111. In FIG. 1, the zeolite membrane 12 is illustrated with bold lines. Alternatively, the support 11 may have a different shape such as a honeycomb shape, a flat plate shape, a tubular shape, a circular cylindrical shape, a circular columnar shape, or a polygonal prism shape.

In the present embodiment, the support 11 is a porous member permeable to gases, and the zeolite membrane 12 is a gas separation membrane. The zeolite membrane 12 may be used for other applications as a molecular separation membrane using a molecular sieving function. For example, the zeolite membrane 12 can be used as a pervaporation membrane. The zeolite membrane complex 1 may be used for still other applications. The type of zeolite constituting the zeolite membrane 12 is not particularly limited. When the zeolite membrane 12 is used as a gas separation membrane, the zeolite membrane 12 is preferably formed of zeolite in which the maximum number of membered rings is 8-membered oxygen ring from the view point of gas permeation amount and separation performance.

As the material for the support 11, various materials may be employed as long as they have chemical stability in the step of forming the zeolite membrane 12 on the surface. Examples of the material for the support 11 include ceramic sintered body, metal, organic polymer, glass, and carbon. Examples of the ceramic sintered body include alumina, silica, mullite, zirconia, titania, yttria, silicon nitride, and silicon carbide. Examples of the metal include aluminum, iron, bronze, stainless steel. Examples of the organic polymer include polyethylene, polypropylene, polytetrafluoroethylene, polysulfone, polyimide.

The support 11 may contain an inorganic binder. The inorganic binder may be at least one of titania, mullite, easily sinterable alumina, silica, glass frit, clay minerals, and easily sinterable cordierite.

The support 11 has a length of, for example, 10 cm to 200 cm. The support 11 has an outer diameter of, for example, 0.5 cm to 30 cm. When the support 11 has a monolith shape, the distance between the central axes of each pair of adjacent through holes is, for example, 0.3 mm to 10 mm. When the support 11 has a tubular shape or a flat plate shape, the support 11 has a thickness of, for example, 0.1 mm to 10 mm.

The surface roughness (Ra) of the support 11 is, for example, 0.1 μm to 5.0 μm and preferably 0.2 μm to 2.0 μM.

When the zeolite membrane 12 is used as a gas separation membrane, the mean pore diameter of the support 11 in the vicinity of the surface on which the zeolite membrane 12 is formed is preferably smaller than that of the other portions. In order to realize such a structure, the support 11 has a multilayer structure. When the support 11 has a multilayer structure, the materials for the respective layers may be those described above, and may be the same or different from each other. The mean pore diameter can be measured by using a mercury porosimeter, a perm porometer, a nano-perm porometer, or the like. The mean pore diameter of the support 11 is, for example, 0.01 μm to 70 μm, and preferably 0.05 μm to 25 μm. The porosity of the support 11 in the vicinity of the surface on which the zeolite membrane 12 is formed is preferably 20% to 60%. Such a structure is preferably provided in a range from 1 μm to 50 μm from the surface thereof.

As to the pore diameter distribution of the support 11, D5 is, for example, 0.01 am to 50 μm, D50 is, for example, 0.05 μm to 70 μm, and D95 is, for example, 0.1 μm to 2000 μm.

The thickness of the zeolite membrane 12 is, for example, 0.05 μm to 30 μm, preferably 0.1 μm to 20 μm, and more preferably 0.5 μm to 10 μm. When the thickness of the zeolite membrane 12 is increased, the gas separation performance increases. When the thickness of the zeolite membrane 12 is reduced, the gas permeance increases.

The surface roughness (Ra) of the zeolite membrane 12 is, for example, not larger than 5 μm, preferably not larger than 2 μm, more preferably not larger than 1 μm, and further preferably not larger than 0.5 μm.

The zeolite membrane 12 is made of, for example, SAT-type zeolite. In other words, the zeolite membrane 12 is made of zeolite having a framework type code of “SAT” assigned by the International Zeolite Association. The zeolite membrane 12 is not limited to the SAT-type zeolite, but may also be zeolite having any one of other structures. The zeolite membrane 12 may be made of, for example, AEI-type, AFN-type, AFX-type, CHA-type, DDR-type, ERI-type, GIS-type, LEV-type, LTA-type, RHO-type zeolite, or the like. The zeolite membrane 12 contains any two or more of silicon (Si), aluminum (Al), and phosphorus (P), or Si. In the present embodiment, the zeolite membrane 12 contains at least Al, P, and O (oxygen). In other words, the zeolite membrane 12 is made of aluminophosphate (AlPO)-based zeolite constituted of Al atoms, P atoms, and O atoms. The maximum number of membered rings of the zeolite constituting the zeolite membrane 12 is preferably 6 or 8. More preferably, the maximum number of membered rings of the zeolite constituting the zeolite membrane 12 is 8. The pore diameter of the zeolite membrane 12 is, for example, 0.30 nm×0.55 nm. As described above, as the material for the support 11, various materials may be adopted. When the zeolite membrane 12 is made of AlPO-based zeolite, the support 11 is preferably an alumina sintered body or a mullite sintered body.

FIG. 2 is an enlarged sectional view of a portion of the zeolite membrane complex 1 in the vicinity of a boundary surface 113 between the zeolite membrane 12 and the support 11. The boundary surface 113 is the inner surface of each through hole 111 (see FIG. 1) of the support 11. In the zeolite membrane complex 1, part of the zeolite membrane 12 is set in the pores of the support 11 through the boundary surface 113. In FIG. 2, the zeolite membrane 12 and a portion of the support 11 into which the zeolite membrane 12 is infiltrated are hatched. In addition, an end (inner end) of the part of the zeolite membrane 12 that is set in the support 11 is denoted by a double dashed chain line 114. The position of the inner end 114 of the zeolite membrane 12 in a direction perpendicular to the boundary surface 113 (hereinafter, referred to as a “depth direction”) is obtained as below. The position of the inner end 114 of the zeolite membrane 12 does not necessarily have to be identical to a critical position in the support 11 where the zeolite disappears.

When the position of the inner end 114 of the zeolite membrane 12 is obtained, first, a cross-sectional surface of the zeolite membrane complex 1 is observed with a scanning electron microscope (SEM), and the position of the boundary surface 113 between the support 11 and the zeolite membrane 12 in the depth direction and the porosity C of the support 11 are obtained. Further, with respect to a main element constituting the zeolite membrane 12 (e.g., P), the atomic percentage A in the zeolite membrane 12 and the atomic percentage B inside the support 11 is determined by an energy dispersive X-ray spectroscope (EDS) in the cross-sectional surface of the zeolite membrane complex 1. The atomic percentage B is an atomic percentage of the above main element constituting the zeolite membrane 12 inside the support 11. Next, a value B/C is calculated by dividing the atomic percentage B by the porosity C of the support 11, and (B/C)/A which is a ratio of B/C to the atomic percentage A (hereinafter, referred to as an “inside-outside element ratio”) is calculated. Then, with respect to the depth direction perpendicular to the boundary surface 113, a position at which the inside-outside element ratio (B/C)/A is 0.8 is obtained as the position of the inner end 114 of the zeolite membrane 12 in the depth direction.

The specific procedure of obtaining the position of the inner end 114 of the zeolite membrane 12 is exemplified as below. When the position of the above boundary surface 113 is obtained, for example, a straight line is set at a position which is considered by an observer of the SEM image to be the boundary between the zeolite membrane 12 and the support 11. Straight lines parallel to the above straight line are arranged in the depth direction. Then, the proportions of the zeolite on the respective straight lines are obtained from the SEM image, and the position of the straight line on which the proportion of the zeolite is 60% is determined as the position of the boundary surface 113 between the support 11 and the zeolite membrane 12. The boundary surface 113 and the above straight lines set in the vicinity of the boundary between the zeolite membrane 12 and the support 11 do not necessarily have to be parallel to the surface 121 of the zeolite membrane 12.

The position of the boundary surface 113 may be obtained by various other methods. For example, in the case where the surface 121 of the zeolite membrane 12 is substantially smooth and the thickness of the zeolite membrane 12 is substantially uniform, after the surface 121 of the zeolite membrane 12 is defined by a straight line in the SEM image, the position of the boundary surface 113 which is parallel to the straight line denoting the surface 121 may be determined by the similar way to the above.

The porosity C of the support 11 is obtained by analyzing the SEM image of the zeolite membrane complex 1 with a known calculation method for porosity with respect to a position where it can be clearly judged in the SEM image that the zeolite membrane 12 set in the support 11 does not reach (for example, the position about 10 cm away from the boundary surface 113 in the depth direction). The calculation position of the porosity C is a position farther from the boundary surface 113 than the inner end 114 of the zeolite membrane 12. The porosity C is preferably an average of porosities obtained at positions in the inner surfaces of the through holes 111 of the support 11. The calculation of the porosity C is performed for the positions in the depth direction each having a porosity similar to that of the portion of the support 11 in the vicinity of the boundary surface 113.

The above main element is preferably one element mainly constituting the framework structure of the zeolite among elements constituting the zeolite membrane 12. The atomic percentage A and the atomic percentage B are determined by compositional analysis with the EDS. The above main element of which the atomic percentage A and the atomic percentage B are determined is an element contained in the zeolite membrane 12, and it is preferable that the main element is not any main element of the support 11. It is more preferable that the above main element is an element that is not essentially contained in the support 11. When the above main element is an element that is not essentially contained in the support 11, the atomic percentage B is a value determined directly with the EDS. The above main element may be an element inevitably contained in the support 11 as an impurity or the like.

In the zeolite membrane complex 1, the distance D in the depth direction between the inner end 114 of the zeolite membrane 12 that is set in the support 11 (i.e., the position at which the inside-outside element ratio (B/C)/A is 0.8) and the boundary surface 113 is preferably not larger than 5 μm, more preferably not larger than 4 μm, and further preferably not larger than 3 μm. In the following description, the distance D is referred to as an “infiltration depth D of the zeolite membrane 12.” The infiltration depth D of the zeolite membrane 12 is preferably not smaller than 0.01 μm, more preferably not smaller than 0.05 μm, and further preferably not smaller than 0.1 μm. The infiltration depth D of the zeolite membrane 12 is preferably not more than 50 times the mean pore diameter of the support 11 in the vicinity of the surface on which the zeolite membrane is formed, more preferably not more than 40 times, and further preferably not more than 30 times. The infiltration depth D of the zeolite membrane 12 is preferably not less than once the mean pore diameter of the support 11 in the vicinity of the surface on which the zeolite membrane is formed, more preferably not less than 1.5 times, and further preferably not less than twice. The regions inside the support 11 in which (B/C)/A is smaller than 0.8 have a low permeation resistance.

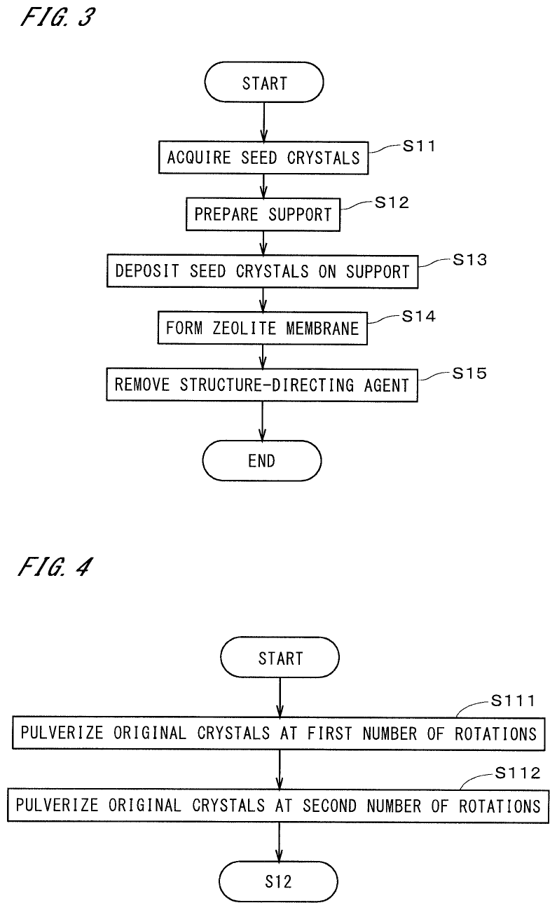

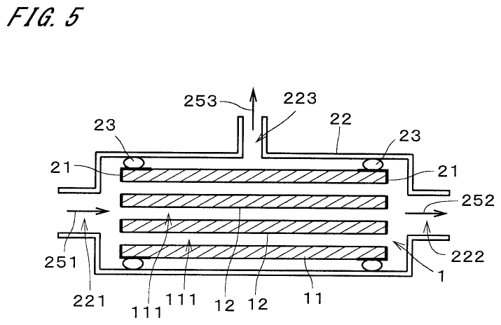

FIGS. 3 and 4 are example flowcharts of production of the zeolite membrane complex 1. First, zeolite powder is synthesized by hydrothermal synthesis, and original crystals are acquired from the zeolite powder. The original crystals contain any two or more of Si, Al, and P, or Si. The original crystals are, for example, SAT-type zeolite. In the present embodiment, the original crystals contain at least Al, P, and O. In other words, the original crystals are AlPO-based zeolite. In the above hydrothermal synthesis, as aluminum source, for example, aluminum hydroxide, aluminum alkoxide, or alumina sol is used.

Subsequently, seed crystals are formed (Step S11). When the seed crystals are formed by pulverizing the original crystals, as shown in FIG. 4, in Step S111, for example, the original crystals are put into a ball mill or a bead mill in a state of being dispersed in a liquid such as pure water or the like. Then, the original crystals are pulverized for a predetermined time by the ball mill or the bead mill rotating at a first number of rotations (Step S111). Next, the number of rotations of the ball mill or the bead mill is changed to a second number of rotations which is lower than the first number of rotations. The ratio of the second number of rotations to the first number of rotations is, for example, not lower than 15% and not higher than 80%. The ratio is more preferably not lower than 20% and not higher than 70%, and further preferably not lower than 30% and not higher than 60%.

Then, by pulverizing the original crystals which have been pulverized in Step S111 for a predetermined time by the ball mill or the bead mill rotating at the second number of rotations, the seed crystals are formed (Step S112). The pulverization time for the original crystals in Step S11 is, for example, not shorter than 2 days and not longer than 13 days. The pulverization time for the original crystals is preferably not shorter than 2 days and not longer than 7 days. The pulverization time in Step S111 is, for example, not shorter than 5 hours and not longer than 48 hours. The pulverization time is more preferably not shorter than 10 hours and not longer than 40 hours, and further preferably not shorter than 15 hours and not longer than 30 hours. In Step S11, the zeolite powder synthesized by the hydrothermal synthesis (i.e., the original crystals) does not necessarily have to be pulverized, and for example, the zeolite powder may be used as the seed crystals as is without pulverization.

The seed crystals acquired in Step S11 are, for example, SAT-type zeolite. The seed crystals contain any two or more of Si, Al, and P, or Si. In the present embodiment, the seed crystals contain at least Al, P, and O. In other words, the seed crystals are ALPO-based zeolite. The specific surface area of the seed crystals is, for example, not smaller than 10 m²/g and not larger than 150 m²/g. The specific surface area of the seed crystals is obtained by single-point BET method.

Further, the strength obtained from a crystal component at a diffraction angle 2θ indicating a maximum peak in a range of diffraction angle 2θ from 12° to 25° in an X-ray diffraction pattern obtained by emitting X-ray to the seed crystals (i.e., peak strength) is, for example, not less than once and not more than 30 times that obtained from an amorphous component. More preferably, the strength obtained from the crystal component is not less than once and not more than 20 times that obtained from the amorphous component. Further preferably, the strength obtained from the crystal component is not less than 1.2 times and not more than 20 times that obtained from the amorphous component. It is known that the zeolite crystals indicate a strong diffraction peak in the range of diffraction angle 2θ from 12° to 25° depending on the crystal structure. For this reason, it is possible to evaluate the crystal component and the amorphous component by adopting the maximum peak in the range of diffraction angle 2θ from 12° to 25° as an evaluation object.

The X-ray used for the X-ray diffraction is a CuKα line. Further, an output of the X-ray is 600 W. By defining the type of X-ray and the output thereof, it is possible to quantitatively evaluate the crystal component and the amorphous component. In the X-ray diffraction, the tube voltage is 40 kV, the tube current is 15 mA, the scanning speed is 5°/min, and the scanning step is 0.02°. As a detector, a scintillation counter is used. The divergence slit is 1.25°, the scattering slit is 1.25°, the receiving slit is 0.3 mm, the incident solar slit is 5.0°, and the light-receiving solar slit is 5.0°. A monochromator is not used, and as a CuKß line filter, used is a nickel foil having a thickness of 0.015 mm. For the measurement of the X-ray diffraction pattern, for example, MiniFlex600 manufactured by Rigaku Corporation can be used. Further, the measurement of the X-ray diffraction pattern is performed in a state where a sample holder having sufficient depth is densely charged with measurement powder.

The strength obtained from the amorphous component is indicated by the line of the bottom in the X-ray diffraction pattern, i.e., the height of a background noise component. The strength obtained from the crystal component is indicated by the height obtained by subtracting the height indicating the strength obtained from the amorphous component from the height in the X-ray diffraction pattern. The above-described line of the bottom in the X-ray diffraction pattern can be obtained, for example, by the Sonneveld-Visser method or the spline interpolation method.

Subsequently, the support 11 is prepared (Step S12). Then, the support 11 is immersed in a solution in which the seed crystals are dispersed, and the seed crystals are thereby deposited on the support 11 (step S13). The support 11 is immersed in the solution, for example, in a state where the longitudinal direction thereof is substantially in parallel with the direction of gravity. Specifically, the inner surface of each through hole 111 is a substantially vertical surface substantially in parallel with the direction of gravity (i.e., a surface with the normal substantially facing in the horizontal direction). Each through hole 111 is filled with the solution in which the seed crystals are dispersed. Then, the solution in each through hole 111 is sucked from an outer side surface of the support 11 through the support 11 to be discharged outside the support 11. The seed crystals contained in the solution do not pass through the support 11 but remain on the inner surface of each through hole 111 and are deposited on the inner surface. Seed crystals deposition support is thereby produced. Further, the seed crystals may be deposited on the support 11 by any other method.

The support 11 on which the seed crystals are deposited in Step S13 (i.e., the seed crystals deposition support) is immersed in a starting material solution. Then, zeolite is grown by the hydrothermal synthesis using the seed crystals as nuclei to form the zeolite membrane 12 on the support 11 (Step S14). The temperature in the hydrothermal synthesis is preferably 110° C. to 200° C. At that time, by adjusting a mixing ratio of aluminum source, phosphorus source and a structure-directing agent (hereinafter, also referred to as an “SDA”) in the starting material solution, or the like, the dense zeolite membrane 12 can be obtained. After that, by heating, the SDA in the zeolite membrane 12 is decomposed and removed (Step S15). In Step S15, the SDA in the zeolite membrane 12 may be completely removed or may partially remain.

Next, with reference to FIG. 5, separation of a mixed substance using the zeolite membrane complex 1 will be described. FIG. 5 is a view of a separation apparatus 2. In the separation apparatus 2, a mixed substance containing a plurality of types of fluids (i.e., gases or liquids) is supplied to the zeolite membrane complex 1, and a substance with high permeability in the mixed substance is caused to permeate the zeolite membrane complex 1, to be thereby separated from the mixed substance. Separation in the separation apparatus 2 may be performed, for example, in order to extract a substance with high permeability from a mixed substance, or in order to concentrate a substance with low permeability.

The mixed substance (i.e., mixed fluid) may be a mixed gas containing a plurality of types of gases, may be a mixed liquid containing a plurality of types of liquids, or may be a gas-liquid two-phase fluid containing both a gas and a liquid.

The mixed substance contains at least one of, for example, hydrogen (H₂), helium (He), nitrogen (N₂), oxygen (O₂), water (H₂O), steam (H₂O), carbon monoxide (CO), carbon dioxide (CO₂), nitrogen oxide, ammonia (NH₃), sulfur oxide, hydrogen sulfide (H₂S), sulfur fluoride, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde.

The nitrogen oxide is a compound of nitrogen and oxygen. The above-described nitrogen oxide is, for example, a gas called NOₓ such as nitric oxide (NO), nitrogen dioxide (NO₂), nitrous oxide (also referred to as dinitrogen monoxide) (N₂O), dinitrogen trioxide (N₂O₃), dinitrogen tetroxide (N₂O₄), dinitrogen pentoxide (N₂O₅), or the like.

The sulfur oxide is a compound of sulfur and oxygen. The above-described sulfur oxide is, for example, a gas called SOₓ such as sulfur dioxide (SO₂), sulfur trioxide (SO₃), or the like.

The sulfur fluoride is a compound of fluorine and sulfur. The above-described sulfur fluoride is, for example, disulfur difluoride (F—S—S—F, S═SF₂), sulfur difluoride (SF₂), sulfur tetrafluoride (SF₄), sulfur hexafluoride (SF₆), disulfur decafluoride (S₂F₁₀), or the like.

The C1 to C8 hydrocarbons are hydrocarbons with not less than 1 and not more than 8 carbon atoms. The C3 to C8 hydrocarbons may be any one of a linear-chain compound, a side-chain compound, and a ring compound. Furthermore, the C2 to C8 hydrocarbons may either be a saturated hydrocarbon (i.e., in which there is no double bond or triple bond in a molecule), or an unsaturated hydrocarbon (i.e., in which there is a double bond and/or a triple bond in a molecule). The C1 to C4 hydrocarbons are, for example, methane (CH₄), ethane (C₂H₆), ethylene (C₂H₄), propane (C₃H₈), propylene (C₃H₆), normal butane (CH₃(CH₂)₂CH₃), isobutane (CH(CH₃)₃), 1-butene (CH₂═CHCH₂CH₃), 2-butene (CH₃CH═CHCH₃), or isobutene (CH₂═C(CH₃)₂).

The above-described organic acid is carboxylic acid, sulfonic acid, or the like. The carboxylic acid is, for example, formic acid (CH₂O₂), acetic acid (C₂H₄O₂), oxalic acid (C₂H₂O₄), acrylic acid (C₃H₄O₂), benzoic acid (C₆H₅COOH), or the like. The sulfonic acid is, for example, ethanesulfonic acid (C₂H₆O₃S) or the like. The organic acid may either be a chain compound or a ring compound.

The above-described alcohol is, for example, methanol (CH₃OH), ethanol (C₂H₅OH), isopropanol (2-propanol) (CH₃CH(OH)CH₃), ethylene glycol (CH₂(OH)CH₂(OH)), butanol (C₄H₉OH), or the like.

The mercaptans are an organic compound having hydrogenated sulfur (SH) at the terminal end thereof, and are a substance also referred to as thiol or thioalcohol. The above-described mercaptans are, for example, methyl mercaptan (CH₃SH), ethyl mercaptan (C₂H₅SH), 1-propanethiol (C₃H₇SH), or the like.

The above-described ester is, for example, formic acid ester, acetic acid ester, or the like.

The above-described ether is, for example, dimethyl ether ((CH₃)₂O), methyl ethyl ether (C₂H₅OCH₃), diethyl ether ((C₂H₅)₂O), or the like.

The above-described ketone is, for example, acetone ((CH₃)₂CO), methyl ethyl ketone (C₂H₅COCH₃), diethyl ketone ((C₂H₅)₂CO), or the like.

The above-described aldehyde is, for example, acetaldehyde (CH₃CHO), propionaldehyde (C₂H₅CHO), butanal (butyraldehyde) (C₃H₇CHO), or the like.

The following description will be made, assuming that a mixed substance to be separated by the separation apparatus 2 is a mixed gas containing a plurality of types of gases.

The separation apparatus 2 includes the zeolite membrane complex 1, sealing parts 21, a housing 22, and two sealing members 23. The zeolite membrane complex 1, the sealing parts 21, and the sealing members 23 are accommodated in the housing 22.

The sealing parts 21 are members which are attached to both end portions of the support 11 in the longitudinal direction (i.e., in the left and right direction of FIG. 5) and cover and seal both end surfaces of the support 11 in the longitudinal direction and an outer side surface of the support 11 in the vicinity of the end surfaces. The sealing parts 21 prevent gas from flowing into or out from both end surfaces of the support 11. The sealing part 21 is, for example, a plate-like member formed of glass or resin. The material and the shape of the sealing part 21 may be changed as appropriate. Further, since the sealing part 21 is provided with a plurality of openings which coincide with the plurality of through holes 111 of the support 11, both ends of each through hole 111 of the support 11 in the longitudinal direction are not covered by the sealing parts 21. Therefore, gas or the like can flow into and out from the through hole 111 from both ends thereof.

The housing 22 is a tubular member having a substantially cylindrical shape. The housing 22 is formed of, for example, stainless steel or carbon steel. The longitudinal direction of the housing 22 is substantially in parallel with the longitudinal direction of the zeolite membrane complex 1. A supply port 221 is provided at an end portion of the housing 22 in the longitudinal direction (i.e., an end portion on the left side in FIG. 5), and a first exhaust port 222 is provided at the other end portion thereof. A second exhaust port 223 is provided on the side surface of the housing 22. The internal space of the housing 22 is a sealed space that is isolated from the space around the housing 22.

The two sealing members 23 are arranged around the entire circumference between the outer side surface of the zeolite membrane complex 1 and the inner side surface of the housing 22 in the vicinity of both end portions of the zeolite membrane complex 1 in the longitudinal direction. Each of the sealing members 23 is a substantially annular member formed of a material that gas cannot permeate. The sealing member 23 is, for example, an O-ring formed of a flexible resin. The sealing members 23 come into close contact with the outer side surface of the zeolite membrane complex 1 and the inner side surface of the housing 22 around the entire circumferences thereof. In the exemplary case shown in FIG. 5, the sealing members 23 come into close contact with outer surfaces of the sealing parts 21 and indirectly come into close contact with the outer side surface of the zeolite membrane complex 1 with the sealing parts 21 interposed therebetween. The portions between the sealing members 23 and the outer side surface of the zeolite membrane complex 1 and between the sealing members 23 and the inner side surface of the housing 22 are sealed, and it is thereby mostly or completely impossible for gas to pass through the portions.

When separation of the mixed gas is performed, a mixed gas containing a plurality of types of gases with different permeabilities for the zeolite membrane 12 is supplied into the internal space of the housing 22 through the supply port 221. For example, the main component of the mixed gas is CO₂ and CH₄. The mixed gas may contain gases other than CO₂ and CH₄. The pressure of the mixed gas to be supplied into the internal space of the housing 22 (i.e., introduction pressure) is, for example, 0.1 MPa to 20.0 MPa. The temperature for separation of the mixed gas is, for example, 10° C. to 200° C.

The mixed gas supplied to the housing 22 is introduced from the left end of the zeolite membrane complex 1 in the drawing into the inside of each through hole 111 of the support 11 as indicated by the arrow 251. Gas with high permeability (which is, for example, CO₂, and hereinafter is referred to as a “high permeability substance”) in the mixed gas permeates the zeolite membrane 12 formed on the inner surface of each through hole 111 and the support 11, and is led out from the outer side surface of the support 11. The high permeability substance is thereby separated from gas with low permeability (which is, for example, CH₄, and hereinafter is referred to as a “low permeability substance”) in the mixed gas. The gas led out from the outer side surface of the support 11 (hereinafter, referred to as a “permeate substance”) is collected through the second exhaust port 223 as indicated by the arrow 253. The pressure of the gas collected through the second exhaust port 223 (i.e., permeation pressure) is, for example, about 1 atmospheric pressure (0.101 MPa).

Further, in the mixed gas, gas other than the gas which has permeated the zeolite membrane 12 and the support 11 (hereinafter, referred to as a “non-permeate substance”) passes through each through hole 111 of the support 11 from the left side to the right side in the drawing and is collected through the first exhaust port 222 as indicated by the arrow 252. The pressure of the gas collected through the first exhaust port 222 is, for example, substantially the same as the introduction pressure. The non-permeate substance may include a high permeability substance that has not permeated the zeolite membrane 12, as well as the above-described low permeability substance.

Next, one example of production of the zeolite membrane complex 1 will be described.

Production of Seed Crystals

As the aluminum source, the phosphorus source, and the SDA (structure-directing agent), aluminum isopropoxide, 85% phosphoric acid, and hydroxy-1,4-diazabicyclo [2.2.2] octane-C4-diquat, respectively, were dissolved in pure water, and a starting material solution having composition of 1 Al₂O₃:1 P₂O₅:0.8 SDA:200 H₂O was thereby produced. This starting material solution was hydrothermally synthesized at 190° C. for 50 hours. The original crystals acquired by the hydrothermal synthesis were collected and sufficiently washed with pure water, and then dried at 100° C. As a result of the X-ray diffraction measurement, it was found that the acquired original crystals were crystals of SAT-type zeolite.

The original crystals were put into pure water so as to have 7 to 8 weight percent, and pulverized by the ball mill for 2 days, 7 days, and 14 days, to thereby obtain three types of seed crystals. As a result of the X-ray diffraction measurement, it was found that the acquired seed crystals were crystals of SAT-type zeolite. Regardless of the pulverization times, the original crystals were pulverized at 330 rpm as the number of rotations in the first part of pulverization, and pulverized at 170 rpm as the number of rotations in the second part. The pulverization time in the first part was one day.

When the total pulverization time (i.e., the total of the pulverization time in the first part and that in the second part) for the original crystals was 2 days, the specific surface area of the seed crystals was about 21 m²/g. Further, the strength obtained from the crystal component at the diffraction angle 2θ indicating the maximum peak in the range of diffraction angle 2θ from 12° to 25° in an X-ray diffraction pattern obtained by emitting X-ray to the seed crystals was about 23 times that obtained from the amorphous component. The diffraction angle 2θ indicating the maximum peak was 21°.

When the total pulverization time for the original crystals was 7 days, the specific surface area of the seed crystals was about 59 m²/g. Further, the strength obtained from the crystal component at the diffraction angle 2θ indicating the maximum peak in the range of diffraction angle 2θ from 12° to 25° in an X-ray diffraction pattern obtained by emitting X-ray to the seed crystals was about 1.3 times that obtained from the amorphous component. The diffraction angle 2θ indicating the maximum peak was 21°.

When the total pulverization time for the original crystals was 14 days, the specific surface area of the seed crystals was about 103 m²/g. Further, the strength obtained from the crystal component at the diffraction angle 2θ indicating the maximum peak in the range of diffraction angle 2θ from 12° to 25° in an X-ray diffraction pattern obtained by emitting X-ray to the seed crystals was about 0.3 times that obtained from the amorphous component. The diffraction angle 2θ indicating the maximum peak was 21°.

As described above, as the total pulverization time for the original crystals was longer, the ratio of the strength obtained from the crystal component to that obtained from the amorphous component became smaller. Specifically, with the pulverization of the original crystals, the crystal component decreased and the amorphous component increased.

Production of Zeolite Membrane

A porous monolith support 11 formed of alumina was prepared. The mean pore diameter of the support 11 in the vicinity of a surface on which the zeolite membrane was to be formed was 0.1 μM. The support 11 was immersed in a solution in which the seed crystals were dispersed, and the seed crystals were thereby deposited on the inner surface of each through hole 111 of the support 11. After that, as the aluminum source, the phosphorus source, and the SDA, aluminum isopropoxide, 85% phosphoric acid, and hydroxy-1,4-diazabicyclo [2.2.2] octane-C4-diquat, respectively, were dissolved in pure water, and a starting material solution having composition of 1 Al₂O₃:2 P₂O₅:2.3 SDA:1000 H₂O was thereby produced.

The support 11 with the seed crystals deposited thereon was immersed in the starting material solution and hydrothermally synthesized at 170° C. for 50 hours. A SAT-type zeolite membrane 12 was thereby formed on the support 11. After the hydrothermal synthesis, the support 11 and the zeolite membrane 12 were sufficiently washed with pure water, and then dried at 100° C. As a result of the X-ray diffraction measurement, it was found that the acquired zeolite membrane 12 was formed of SAT-type zeolite.

After drying the support 11 and the zeolite membrane 12, the N₂ (nitrogen) permeation amount through the zeolite membrane 12 was measured. The N₂ permeation amount through the zeolite membrane 12 formed by using the seed crystals obtained by pulverization for the total pulverization time of 2 days and that through the zeolite membrane 12 formed by using the seed crystals obtained by pulverization for the total pulverization time of 7 days were each not larger than 0.005 nmol/m²·s·Pa. It was thereby confirmed that the zeolite membrane 12 formed by using the seed crystals obtained by pulverization for the total pulverization time of 2 days to 7 days was dense enough for practical use. After that, the zeolite membrane 12 was subjected to heat treatment at 500° C. for 50 hours so as to burn and remove the SDA and to cause micropores in the zeolite membrane 12 to come through the membrane.

On the other hand, the N₂ permeation amount through the zeolite membrane 12 formed by using the seed crystals obtained by pulverization for the total pulverization time of 14 days was 0.2 nmol/m²·s·Pa, and it was confirmed that the zeolite membrane had not suitably grown as compared with the case using the seed crystals obtained by pulverization for the total pulverization time of 2 days or 7 days. Even in the case where the total pulverization time is long and thereby the crystal component in the seed crystals decreases, the denseness of the zeolite membrane may be improved by changing hydrothermal synthesis condition. For example, the zeolite membrane may become dense enough for practical use by increasing the hydrothermal synthesis time. When the zeolite membrane was formed by hydrothermal synthesis at 170° C. for 100 hours with use of the seed crystals obtained by pulverization for the total pulverization time of 14 days, the zeolite membrane could be densified to the extent that the N₂ permeation amount through the zeolite membrane was not larger than 0.005 nmol/m²·s·Pa.

Gas Separation Test

Next, a separation test for a mixed gas was carried out by using an apparatus having a schematic structure shown in FIG. 5. As described above, the zeolite membrane 12 was formed on the inner surfaces of the plurality of through holes 111 provided in the support 11. Both end portions of the support 11 were sealed with the glasses 21, and the support 11 was accommodated in the housing 22. In this state, the mixed gas was introduced into each through hole 111 of the support 11 as indicated by the arrow 251 and the gas which had permeated the zeolite membrane 12 was collected from the second exhaust port 223 provided in the housing 22 as indicated by the arrow 253.

The gas introduction pressure in the separation test was 0.2 MPaG. As the above-described mixed gas, the gas with a ratio between the CO₂ and CH₄ being 50:50 was used. As a result, the permeance ratio of CO₂/CH₄ in the zeolite membrane 12 formed by using the seed crystals obtained by pulverization for the total pulverization time of 2 days was 1750. Further, the permeance ratio of CO₂/CH₄ in the zeolite membrane 12 formed by using the seed crystals obtained by pulverization for the total pulverization time of 7 days was 1800. It was thereby confirmed that the zeolite membrane 12 formed by using the seed crystals obtained by pulverization for the total pulverization time of 2 days to 7 days had enough separation performance for practical use. When the zeolite membrane 12 was formed by hydrothermal synthesis at 170° C. for 100 hours with use of the seed crystals obtained by pulverization for the total pulverization time of 14 days, the permeance ratio of CO₂/CH₄ in the zeolite membrane 12 was 200. It was thereby confirmed that the zeolite membrane 12 separated the above mixed gas although the zeolite membrane 12 had lower separation performance than the zeolite membrane 12 of the total pulverization time of 2 days to 7 days.

Next, with reference to Tables 1 and 2, Experimental Examples and Comparative Examples each showing a relationship between the infiltration depth D of the zeolite membrane 12 and pressure loss in gas permeation through the zeolite membrane complex 1 will be described. Experimental Examples 1 and 2 were the zeolite membrane complexes 1 in each of which the zeolite membrane 12 was synthesized on the support 11 by the above production method. In Experimental Examples 1 and 2, the total pulverization time for the original crystals in production of the seed crystals was 2 days to 7 days. Comparative Example 1 was the zeolite membrane complex 1 in which the zeolite membrane was synthesized by the similar way to Experimental Examples 1 and 2 except that the total pulverization time for the original crystals in production of the seed crystals was changed to 14 days and the hydrothermal synthesis time was twice that of Experimental Examples 1 and 2.

In the zeolite membrane complex 1 of Experimental Example 3, the zeolite membrane 12 was made of DDR-type zeolite. The zeolite membrane 12 of Experimental Example 3 contained Si as the main element. In Experimental Example 3, the total pulverization time for the original crystals in production of the seed crystals was 2 days, and therefore the specific surface area of the seed crystals was about 15 m²/g. Further, the strength obtained from the crystal component at the diffraction angle 2θ indicating the maximum peak in the range of diffraction angle 2θ from 12° to 25° in an X-ray diffraction pattern obtained by emitting X-ray to the seed crystals was about 29 times that obtained from the amorphous component. The diffraction angle 2θ indicating the maximum peak was 17°. The zeolite membrane 12 was synthesized by the method described as Example 1 in International Publication WO 2011/105511. The N₂ permeation amount through the zeolite membrane 12 was not larger than 0.005 nmol/m²·s·Pa. It was thereby confirmed that the zeolite membrane 12 was dense enough for practical use. After that, the zeolite membrane 12 was subjected to heat treatment at 500° C. for 50 hours so as to burn and remove the SDA and to cause micropores in the zeolite membrane 12 to come through the membrane.

In the zeolite membrane complex 1 of Experimental Example 4, the zeolite membrane 12 was made of CHA-type zeolite. The zeolite membrane 12 of Experimental Example 4 contained Si as the main element. In Experimental Example 4, the total pulverization time for the original crystals in production of the seed crystals was 2 days, and therefore the specific surface area of the seed crystals was about 30 m²/g. Further, the strength obtained from the crystal component at the diffraction angle 2θ indicating the maximum peak in the range of diffraction angle 2θ from 12° to 25° in an X-ray diffraction pattern obtained by emitting X-ray to the seed crystals was about 10 times that obtained from the amorphous component. The diffraction angle 2θ indicating the maximum peak was 21°. The zeolite membrane 12 was synthesized by the method described as “formation of chabazite-type zeolite membrane” in Japanese Patent Application Laid-Open No. 2014-198308 by reference to Comparative Example 2 in the document. The N₂ permeation amount through the zeolite membrane 12 was not larger than 0.005 nmol/m²·s·Pa. It was thereby confirmed that the zeolite membrane 12 was dense enough for practical use. After that, the zeolite membrane 12 was subjected to heat treatment at 500° C. for 50 hours so as to burn and remove the SDA and to cause micropores in the zeolite membrane 12 to come through the membrane.

Comparative Example 2 was the zeolite membrane complex obtained by changing the total pulverization time for the original crystals in production of the seed crystals of Experimental Example 4 to 14 days and synthesizing a CHA-type zeolite membrane. The specific surface area of the seed crystals in Comparative Example 2 was about 65 m²/g. Further, the strength obtained from the crystal component at the diffraction angle 2θ indicating the maximum peak in the range of diffraction angle 2θ from 12° to 25° in an X-ray diffraction pattern obtained by emitting X-ray to the seed crystals was about 0.7 times that obtained from the amorphous component. The diffraction angle 2θ indicating the maximum peak was 21°. In Comparative Example 2, the synthesis time was set to twice that in Experimental Example 4, because the denseness of the membrane synthesized with the same hydrothermal synthesis condition as Experimental Example 4 was low. By this, the N₂ permeation amount through the formed zeolite membrane became not larger than 0.005 nmol/m²·s·Pa. It was thereby confirmed that the zeolite membrane was dense enough for practical use. After that, the zeolite membrane was subjected to heat treatment at 500° C. for 50 hours so as to burn and remove the SDA and to cause micropores in the zeolite membrane to come through the membrane.

In Table 1, the atomic percentage A of P, which is a main element, in the zeolite membrane 12, the atomic percentage B of P inside the support 11, the porosity C of the support 11, and the inside-outside element ratio (B/C)/A are shown for the zeolite membrane complexes 1 of Experimental Examples 1 and 2. The same applies to Comparative Example 1. Further, the atomic percentage A of Si, which is a main element, in the zeolite membrane 12, the atomic percentage B of Si inside the support 11, the porosity C of the support 11, and the inside-outside element ratio (B/C)/A are shown for the zeolite membrane complexes 1 of Experimental Examples 3 and 4. The same applies to Comparative Example 2. As for the atomic percentage B and the inside-outside element ratio (B/C)/A, values at positions with different depths from the boundary surface 113 are shown.

In Table 2, the infiltration depth D of the zeolite membrane 12 which is obtained from the measurement results shown in Table 1, and the CO₂ permeation amount (nmol/m²·s·Pa) which is a parameter indicating pressure loss in the zeolite membrane complex 1 are shown for the zeolite membrane complexes 1 of Experimental Examples 1 to 4. The same applies to Comparative Examples 1 and 2. Note that the elements constituting the supports 11 of Experimental Examples 1 and 2, and the elements constituting the support of Comparative Example 1 do not essentially contain P. The elements constituting the supports 11 of Experimental Examples 3 and 4, and the elements constituting the support of Comparative Example 2 do not essentially contain Si.

TABLE 1

| | | | Atomic | Depth from | Atomic | | |
|---|---|---|---|---|---|---|---|
| | Type of | Analyzed | Percentage | Boundary | Percentage | Porosity | |
| | Zeolite | Element | A (atm %) | Surface (μm) | B (atm %) | C (%) | (B/A)/C |
| Experimental | SAT | P | 16.7 | 1 | 4.2 | 0.30 | 0.84 |
| Example 1 | | | | 2 | 2.8 | | 0.56 |
| | | | | 3 | 2.2 | | 0.44 |
| Experimental | SAT | P | 16.7 | 3 | 4.7 | 0.30 | 0.94 |
| Example 2 | | | | 4 | 4.4 | | 0.88 |
| | | | | 5 | 0.7 | | 0.14 |
| Experimental | DDR | Si | 33.3 | 1 | 8.3 | 0.30 | 0.83 |
| Example 3 | | | | 2 | 5.5 | | 0.55 |
| | | | | 3 | 2.0 | | 0.20 |
| Experimental | CHA | Si | 31.3 | 3 | 8.2 | 0.30 | 0.87 |
| Example 4 | | | | 4 | 5.9 | | 0.63 |
| | | | | 5 | 1.5 | | 0.16 |
| Comparative | SAT | P | 16.7 | 4 | 4.6 | 0.30 | 0.92 |
| Example 1 | | | | 5 | 4.1 | | 0.82 |
| | | | | 6 | 1.8 | | 0.36 |
| Comparative | CHA | Si | 31.3 | 4 | 8.4 | 0.30 | 0.89 |
| Example 2 | | | | 5 | 7.7 | | 0.82 |
| | | | | 6 | 4.1 | | 0.44 |

TABLE 2

| | | CO₂ |
|---|---|---|
| | Infiltration Depth | Permeation |
| | D | Amount |
| | (μm) | (nmol/m²/Pa/s) |
| Experimental | larger than 1 and smaller than 2 | 2100 |
| Example 1 | | |
| Experimental | larger than 4 and smaller than 5 | 1400 |
| Example 2 | | |
| Experimental | larger than 1 and smaller than 2 | 1000 |
| Example 3 | | |
| Experimental | larger than 3 and smaller than 4 | 1900 |
| Example 4 | | |
| Comparative | larger than 5 and smaller than 6 | 450 |
| Example 1 | | |
| Comparative | larger than 5 and smaller than 6 | 500 |
| Example 2 | | |

In Experimental Examples 1 to 4, the infiltration depth D of the zeolite membrane 12 is not larger than 5 μm, and the CO₂ permeation amount is not smaller than 1000. Thus, in Experimental Examples 1 to 4, the pressure loss in gas permeation through the zeolite membrane complex 1 is in the preferred range. In Comparative Examples 1 and 2, the infiltration depth D of the zeolite membrane 12 is larger than 5 μm, and the CO₂ permeation amount is not larger than 500. Thus, in Comparative Examples 1 and 2, the pressure loss in gas permeation through the zeolite membrane complex 1 is large, and the permeability is low. The thicknesses of the zeolite membranes in Experimental Examples 1 to 4 and Comparative Examples 1 and 2 are all about the same, and they are around 5 μm. As for Experimental Examples 2 and 4, and Comparative Examples 1 and 2, when the insides of the supports were observed with a SEM, the respective positions at each of which a void (i.e., a void appearing by a pore of the support) was first observed in the depth direction perpendicular to the boundary surface between the zeolite membrane and the support were similar, and they were around 2 to 3 am away from the boundary surface.

As described above, the zeolite membrane complex 1 includes a porous support 11, and a zeolite membrane 12 formed on the support 11. Part of the zeolite membrane 12 is set in pores of the support 11 through the boundary surface 113 between the zeolite membrane 12 and the support 11. With respect to a main element constituting the zeolite membrane 12, the distance D in the depth direction perpendicular to the boundary surface 113 between a position at which the inside-outside element ratio (B/C)/A is 0.8 and the boundary surface 113 (i.e., the infiltration depth D of the zeolite membrane 12) is preferably not larger than 5 μm. B/C is a value obtained by dividing the atomic percentage B of the main element inside the support 11 by the porosity C of the support 11. The inside-outside element ratio (B/C)/A is a ratio of the value to the atomic percentage A of the main element in the zeolite membrane 12.

Because the part of the zeolite membrane 12 is caused to be set in the pores of the support 11 and the infiltration depth D of the zeolite membrane 12 is made not larger than 5 μm as above, it is possible to increase permeability of the zeolite membrane complex 1 while maintaining adhesion of the zeolite membrane 12 to the support 11. In the zeolite membrane complex 1, the infiltration depth D of the zeolite membrane 12 is made not larger than 4 μm, and this makes it possible to further increase the permeability of the zeolite membrane complex 1 while maintaining the adhesion of the zeolite membrane 12 to the support 11. The infiltration depth D of the zeolite membrane 12 is made not larger than 3 μm, and this makes it possible to much further increase the permeability of the zeolite membrane complex 1 while maintaining the adhesion of the zeolite membrane 12 to the support 11. From the viewpoint of improving the adhesion of the zeolite membrane 12 to the support 11, the infiltration depth D of the zeolite membrane 12 is preferably not smaller than 0.01 μm, more preferably not smaller than 0.05 μm, and further preferably not smaller than 0.1 μm.

With respect to the main element constituting the zeolite membrane 12, the distance D in the depth direction perpendicular to the boundary surface 113 between the position at which the inside-outside element ratio (B/C)/A is 0.8 and the boundary surface 113 (i.e., the infiltration depth D of the zeolite membrane 12) is preferably not more than 50 times the mean pore diameter of the support 11 in the vicinity of the surface on which the zeolite membrane 12 is formed. It is therefore possible to increase the permeability of the zeolite membrane complex 1 while maintaining the adhesion of the zeolite membrane 12 to the support 11, as with the above. The infiltration depth D of the zeolite membrane 12 is preferably not smaller than once the mean pore diameter of the support 11 in the vicinity of the surface on which the zeolite membrane 12 is formed. This improves the adhesion of the zeolite membrane 12 to the support 11.

In the zeolite membrane complex 1, the above-described main element is preferably an element that is not essentially contained in the support 11. This makes it possible to easily determine the atomic percentage B of the main element inside the support 11. As a result, the infiltration depth D of the zeolite membrane 12 can be easily obtained.

As described above, the zeolite membrane 12 of Experimental Examples 1 and 2 contains at least Al, P, and O. When the zeolite membrane 12 is aluminophosphate-based zeolite as above, the atomic percentages of Al and P in the zeolite membrane 12 are almost the same. Thus, even when Al is contained in constituent elements of the support 11, the atomic percentage of Al inside the support 11 can be easily obtained by determining the atomic percentage of P inside the support 11.

In the zeolite membrane complex 1, the support 11 is an alumina sintered body or a mullite sintered body. This improves the adhesion of the seed crystals to the support 11.

The method of producing the zeolite membrane complex 1 includes a step of synthesizing zeolite by hydrothermal synthesis and obtaining seed crystals from the zeolite (Step S11), a step of depositing the seed crystals on a porous support 11 (Step S13), and a step of immersing the support 11 in a starting material solution and growing zeolite from the seed crystals by hydrothermal synthesis, to thereby form a zeolite membrane 12 on the support 11 (Step S14).

The part of the zeolite membrane 12 is set in the pores of the support 11 through the boundary surface 113 between the zeolite membrane 12 and the support 11 as above. The infiltration depth D of the zeolite membrane 12 derived from the main element constituting the zeolite membrane 12 is preferably not larger than 5 μm. It is therefore possible to increase the permeability of the zeolite membrane complex 1 while maintaining the adhesion of the zeolite membrane 12 to the support 11. From the viewpoint of increasing the permeability of the zeolite membrane complex 1 while maintaining the adhesion of the zeolite membrane 12 to the support 11, the infiltration depth D of the zeolite membrane 12 is more preferably not larger than 4 μm, and further preferably not larger than 3 μm. The infiltration depth D of the zeolite membrane 12 is preferably not smaller than 0.01 μm, more preferably not smaller than 0.05 μm, and further preferably not smaller than 0.1 μm. This improves the adhesion of the zeolite membrane 12 to the support 11.

As described above, the infiltration depth D of the zeolite membrane 12 is preferably not more than 50 times the mean pore diameter of the support 11 in the vicinity of the surface on which the zeolite membrane 12 is formed. It is therefore possible to increase the permeability of the zeolite membrane complex 1 while maintaining the adhesion of the zeolite membrane 12 to the support 11, as with the above. The infiltration depth D of the zeolite membrane 12 is preferably not smaller than once the mean pore diameter of the support 11 in the vicinity of the surface on which the zeolite membrane 12 is formed. This improves the adhesion of the zeolite membrane 12 to the support 11.

In production of the zeolite membrane complex 1, the specific surface area of the seed crystals obtained in the Step S11 is not smaller than 10 m²/g and not larger than 150 m²/g. This makes it possible to densely deposit the seed crystals on the support 11. The strength obtained from the crystal component at the diffraction angle 2θ indicating the maximum peak in the range of diffraction angle 2θ from 12° to 25° in an X-ray diffraction pattern obtained by emitting X-ray to the seed crystals is not less than once and not more than 30 times that obtained from the amorphous component. Thus, by setting the strength obtained from the crystal component to be not more than 30 times that obtained from the amorphous component, it is possible to make the proportion of the amorphous component in the seed crystals relatively large and improve the adhesion of the seed crystals to the support 11. As a result, it is possible to densely and uniformly deposit the seed crystals on the support 11. Further, by setting the strength obtained from the crystal component to be not less than once that obtained from the amorphous component, it is possible to prevent the proportion of the crystal component in the seed crystals from becoming excessively small and suitably grow the zeolite in the formation of the zeolite membrane 12. As a result, it is possible to form the dense zeolite membrane 12 on the support 11.

The seed crystals are easily deposited on the support, and therefore suitable for seed crystals of zeolite (for example, zeolite containing any two or more of Si, Al, and P or Si) which are required to improve the adhesion to the support. Further, the seed crystals are especially suitable for seed crystals of zeolite (for example, zeolite containing at least Al, P, and O) which are conventionally thought to be hard to be deposited on a general-type support.

The seed crystals achieve improvement in the adhesion to the support as described above, and therefore especially suitable for seed crystals to be deposited on a surface (for example, a substantially vertical surface in production of the zeolite membrane complex 1) on which seed crystals are hard to be deposited because of the gravity effect, out of the surfaces of the support 11. From the same point of view, the seed crystals are especially suitable for seed crystals to be deposited on a downward-facing surface in production of the zeolite membrane complex 1, out of the surfaces of the support 11. In any case, it is possible to densely and uniformly deposit the seed crystals on the support 11. Further, the above-described downward-facing surface is a surface whose normal is downward from the horizontal direction, and includes both a surface whose normal is vertically downward and a surface whose normal is diagonally downward. As a matter of course, the seed crystals may be deposited on any surface facing in any direction such as an upward-facing surface or the like, only if deposited on the surface of the support 11.

The above-described zeolite membrane complex 1 and method of producing the same allow various variations.

For example, the method of producing the seed crystals used for synthesis of the zeolite membrane 12 is not limited to the one described above, and may be modified in various ways. The specific surface area of the seed crystals may be smaller than 10 m²/g or larger than 150 m²/g. Further, by additionally changing the pulverization condition for the original crystals, the cases were checked, where the specific surface area of the seed crystals was smaller than 10 m²/g and where the specific surface area was larger than 150 m²/g. When the specific surface area of the seed crystals was smaller than 10 m²/g, it was confirmed that the adhesion of the seed crystals to the support 11 was reduced to some degree, as compared with the case where the specific surface area of the seed crystals is not smaller than 10 m²/g and not larger than 150 m²/g. When the specific surface area of the seed crystals was larger than 150 m²/g, it was confirmed that the growth of zeolite was suppressed to some degree in the production of the zeolite membrane 12, as compared with the case where the specific surface area of the seed crystals was not smaller than 10 m²/g and not larger than 150 m²/g. Further, the strength obtained from the crystal component at the diffraction angle 2θ indicating the maximum peak in the range of diffraction angle 2θ from 12° to 25° in an X-ray diffraction pattern obtained by emitting X-ray to the seed crystals may be less than once that obtained from the amorphous component, or may be more than 30 times.

The element of which the atomic percentages A and B are determined when obtaining the infiltration depth D of the zeolite membrane 12 may be an element (e.g., Al) contained in the support 11 as long as it is contained in main elements of the zeolite membrane 12. In this case, the atomic percentage B of the element contained in the zeolite membrane 12 that is set in the pores of the support 11 is calculated by subtracting a value equivalent to an atomic percentage of the element contained in particles constituting the support 11 from an atomic percentage of the element measured inside the support 11. The infiltration depth D of the zeolite membrane 12 may be obtained using atomic percentages A and B of a plurality of elements out of main elements of the zeolite membrane 12. For example, there may be a case where a plurality of infiltration depths of the zeolite membrane 12 are obtained using the plurality of elements, respectively and an average of the plurality of infiltration depths is obtained as the infiltration depth D of the zeolite membrane 12.

In the case where the infiltration depth D of the zeolite membrane 12 is not larger than 5 μm, the infiltration depth D does not have to be 50 times or less the mean pore diameter of the support 11 in the vicinity of the surface on which the zeolite membrane 12 is formed, but may be more than 50 times the mean pore diameter. Further, in the case where the infiltration depth D of the zeolite membrane 12 is not more than 50 times the mean pore diameter of the support 11 in the vicinity of the surface on which the zeolite membrane 12 is formed, the infiltration depth D does not necessarily have to be smaller than or equal to 5 μm, but may be greater than 5 μm.

As described above, the seed crystals and the zeolite membrane 12 are not limited to those of SAT-type zeolite, but may be those of zeolite having any other structure. The seed crystals and the zeolite membrane 12 do not have to be pure aluminophosphate, but may contain any other element. For example, the seed crystals and the zeolite membrane 12 may contain Mg atoms, Si atoms, or the like. Further, the seed crystals and the zeolite membrane 12 do not necessarily have to contain two or more of Si, Al, and P. For example, the seed crystals and the zeolite membrane 12 may be those of substances mainly containing SiO₂ (silicalite or the like). The seed crystals and the zeolite membrane 12 do not necessarily have to contain Si.

As to the above-described seed crystals (specifically, in which the specific surface area is not smaller than 10 m²/g and not larger than 150 m²/g and the strength obtained from the crystal component at the above-described diffraction angle 2θ in an X-ray diffraction pattern is not less than once and not more than 30 times that obtained from the amorphous component), besides for the above-described SAT-type zeolite, for DDR-type zeolite containing Si, CHA-type zeolite containing Si and Al, AFX-type zeolite containing Si, Al, and P, AEI-type zeolite containing Al and P, and ERI-type zeolite containing Al and P, it is similarly confirmed that the adhesion of the seed crystals to the support can be improved.

The zeolite membrane complex 1 may further include a function layer or a protective layer laminated on the zeolite membrane 12. Such a function layer or a protective layer is not limited to the zeolite membrane, but may be an inorganic membrane such as a carbon membrane, a silica membrane, or the like, or an organic membrane such as a polyimide membrane, a silicone membrane, or the like.

The configurations in the above-discussed preferred embodiments and variations may be combined as appropriate only if these do not conflict with one another.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The zeolite membrane complex according to the present invention can be used as, for example, a gas separation membrane, and can also be used in various fields using zeolites, for example as a separation membrane for substances other than gases or as an adsorption membrane for various substances.

### REFERENCE SIGNS LIST

1 Zeolite membrane complex
11 Support
12 Zeolite membrane
113 Boundary surface (between support and zeolite membrane)
S11 to S15, S111, S112 Step

1. A zeolite membrane complex comprising:
a porous support; and
a zeolite membrane formed on said support, wherein
part of said zeolite membrane is set in pores of said support over a boundary surface between said zeolite membrane and said support, and
a distance between said boundary surface and a position in a depth direction perpendicular to said boundary surface is not smaller than 0.01 μm and not larger than 5 μm, where with respect to a main element constituting said zeolite membrane, a ratio (B/C)/A of a value obtained by dividing an atomic percentage B at said position inside said support by a porosity C of said support, to an atomic percentage A in said zeolite membrane is 0.8.

2. The zeolite membrane complex according to claim 1, wherein
said distance is not larger than 4 μm.

3. The zeolite membrane complex according to claim 2, wherein
said distance is not larger than 3 μm.

4. A zeolite membrane complex comprising:
a porous support; and
a zeolite membrane formed on said support, wherein
part of said zeolite membrane is set in pores of said support over a boundary surface between said zeolite membrane and said support, and
a distance between said boundary surface and a position in a depth direction perpendicular to said boundary surface is not smaller than 0.01 μm and not more than 50 times a mean pore diameter of said support in a vicinity of a surface on which said zeolite membrane is formed, where with respect to a main element constituting said zeolite membrane, a ratio (B/C)/A of a value obtained by dividing an atomic percentage B at said position inside said support by a porosity C of said support, to an atomic percentage A in said zeolite membrane is 0.8.

5. The zeolite membrane complex according to claim 1, wherein
said main element is an element that is not essentially contained in said support.

6. The zeolite membrane complex according to claim 1, wherein
said zeolite membrane contains any two or more of silicon, aluminum, and phosphorus, or silicon.

7. The zeolite membrane complex according to claim 1, wherein
said support is an alumina sintered body or a mullite sintered body.

8. A method of producing a zeolite membrane complex, comprising:
a) synthesizing zeolite by hydrothermal synthesis and obtaining seed crystals from said zeolite;
b) depositing said seed crystals on a porous support; and
c) immersing said support in a starting material solution and growing zeolite from said seed crystals by hydrothermal synthesis, to thereby form a zeolite membrane on said support, wherein
part of said zeolite membrane is set in pores of said support over a boundary surface between said zeolite membrane and said support, and
a distance between said boundary surface and a position in a depth direction perpendicular to said boundary surface is not smaller than 0.01 μm and not larger than 5 μm, where with respect to a main element constituting said zeolite membrane inside said support, a ratio (B/C)/A of a value obtained by dividing an atomic percentage B at said position inside said support by a porosity C of said support, to an atomic percentage A in said zeolite membrane is 0.8.

9. The method of producing a zeolite membrane complex according to claim 8, wherein
said distance is not larger than 4 μm.

10. The method of producing a zeolite membrane complex according to claim 9, wherein
said distance is not larger than 3 μm.

11. A method of producing a zeolite membrane complex, comprising:
a) synthesizing zeolite by hydrothermal synthesis and obtaining seed crystals from said zeolite;
b) depositing said seed crystals on a porous support; and
c) immersing said support in a starting material solution and growing zeolite from said seed crystals by hydrothermal synthesis, to thereby form a zeolite membrane on said support, wherein
part of said zeolite membrane is set in pores of said support over a boundary surface between said zeolite membrane and said support, and
a distance between said boundary surface and a position in a depth direction perpendicular to said boundary surface is not smaller than 0.01 μm and not more than 50 times a mean pore diameter of said support in a vicinity of a surface on which said zeolite membrane is formed, where with respect to a main element constituting said zeolite membrane inside said support, a ratio (B/C)/A of a value obtained by dividing an atomic percentage B at said position inside said support by a porosity C of said support, to an atomic percentage A in said zeolite membrane is 0.8.

12. The method of producing a zeolite membrane complex according to claim 8, wherein
a specific surface area of said seed crystals obtained in said operation a) is not smaller than 10 m²/g and not larger than 150 m²/g, and
a strength obtained from a crystal component at a diffraction angle 2θ indicating a maximum peak in a range of diffraction angle 2θ from 12° to 25° in an X-ray diffraction pattern obtained by emitting X-ray to said seed crystals is not less than once and not more than 30 times that obtained from an amorphous component.

13. The method of producing a zeolite membrane complex according to claim 8, wherein
said seed crystals are deposited in said operation b) on a substantially vertical surface or a downward-facing surface in production of said zeolite membrane complex, out of surfaces of said support.

14. The zeolite membrane complex according to claim 1, wherein
said distance is not more than 50 times a mean pore diameter of said support in a vicinity of a surface on which said zeolite membrane is formed.

15. The zeolite membrane complex according to claim 4, wherein
said main element is an element that is not essentially contained in said support.

16. The zeolite membrane complex according to claim 4, wherein
said zeolite membrane contains any two or more of silicon, aluminum, and phosphorus, or silicon.

17. The zeolite membrane complex according to claim 4, wherein
said support is an alumina sintered body or a mullite sintered body.

18. The method of producing a zeolite membrane complex according to claim 8, wherein
said distance is not more than 50 times a mean pore diameter of said support in a vicinity of a surface on which said zeolite membrane is formed.

19. The method of producing a zeolite membrane complex according to claim 11, wherein
a specific surface area of said seed crystals obtained in said operation a) is not smaller than 10 m²/g and not larger than 150 m²/g, and
a strength obtained from a crystal component at a diffraction angle 2θ indicating a maximum peak in a range of diffraction angle 2θ from 12° to 25° in an X-ray diffraction pattern obtained by emitting X-ray to said seed crystals is not less than once and not more than 30 times that obtained from an amorphous component.

20. The method of producing a zeolite membrane complex according to claim 11, wherein
said seed crystals are deposited in said operation b) on a substantially vertical surface or a downward-facing surface in production of said zeolite membrane complex, out of surfaces of said support.
